(19) United States
(12) Patent Application Publication
(10) Pub. No.: US 2026/0327042 A1
(43) Pub. Date: Oct. 22, 2026

(54) GUIDE RAIL CLIP, GUIDE RAIL BRACKET ASSEMBLY, AND ELEVATOR SYTEM

(71) Applicant: Otis Elevator Company, Farmington, CT (US)

(72) Inventors: Zhimin Hu, Shanghai (CN); Jianye Yang, Shanghai (CN)

(21) Appl. No.: 19/413,760

(22) Filed: Dec. 9, 2025

(30) Foreign Application Priority Data
Apr. 16, 2025 (CN) 202510479488.9

(51) Int. Cl. B66B 7/02

(52) U.S. Cl. CPC B66B 7/023

(57) ABSTRACT

A guide rail clip, a guide rail bracket assembly, and an elevator system. The guide rail clip (1) includes a main body (11) securely disposed and a clipping section (12) extending from the main body (11), a first portion (121) of the clipping section (12) is configured for abutment engagement with a side surface (1091) of the guide rail (109), and a second portion (122) of the clipping section (12) is configured for point-to-surface engagement with an end face (1092) of the guide rail (109).

### FOREIGN PRIORITY

This application claims priority to Chinese Patent Application No. 202510479488.9, filed Apr. 16, 2025, and all the benefits accruing therefrom under 35 U.S.C. § 119, the contents of which in its entirety are herein incorporated by reference.

### TECHNICAL FIELD

The present disclosure relates to the field of elevator guide rail clips, and more specifically, to a guide rail clip, a guide rail bracket assembly and an elevator system.

### BACKGROUND

This section is intended to provide background information related to understanding the various technologies described herein. As implied by the title of this section, it should under no circumstances be construed as necessarily suggesting a discussion of technologies pertaining to prior art. Accordingly, it should be understood that any statements in this section should be interpreted from this perspective, rather than as any acknowledgment of prior art.

According to Chinese elevator standards (GB/T 7588.1-2020) and European elevator standards (EN81-20:2014), the force applied to a guide rail in the perpendicular direction (up and down direction, i.e., the direction of elevator operation) should account for friction between a guide rail clip and a guide rail surface. Conventional guide rail clips (forged or steel plate type) apply a relatively large friction force perpendicularly onto a guide rail (generally about 2000 N per set of guide rail clips). As the number of guide rail clip sets increases, the friction force accumulates at that point, thus requiring the selection of larger and stronger guide rails to satisfy guide rail buckling calculations, which in turn leads to a significant increase in the cost of guide rails.

### SUMMARY

An object of the present disclosure is to solve or at least mitigate the problems existing in prior art.

According to one aspect, a guide rail clip for a guide rail bracket assembly of a guide rail of an elevator system is provided, wherein the guide rail clip comprises a main body securely disposed and a clipping section extending from the main body, wherein a first portion of the clipping section is configured for abutment engagement with a side surface of the guide rail, and a second portion of the clipping section is configured for point-to-surface engagement with an end face of the guide rail.

Optionally, according to an embodiment of the present disclosure, the clipping section is configured as steel wire.

Optionally, according to an embodiment of the present disclosure, viewed in a longitudinal extension direction of the guide rail, the first portion is arranged angularly relative to a horizontal direction, and the second portion is arranged angularly relative to the end face of the guide rail.

Optionally, according to an embodiment of the present disclosure, the main body is capable of being at least partially arranged around an outer peripheral surface of a bolt for securing the main body.

According to another aspect, a guide rail bracket assembly for a guide rail of an elevator system is provided, wherein the guide rail bracket assembly comprises any of the guide rail clips as described above, a bolt and a guide rail bracket, and wherein the main body is secured to the guide rail bracket by means of the bolt, and the guide rail bracket is capable of being securely disposed on a wall.

Optionally, according to an embodiment of the present disclosure, the guide rail bracket comprises a first plate member and a second plate member, wherein the main body is secured to the first plate member by means of the bolt, the second plate member is capable of being securely disposed on a wall, the first plate member is provided with a first elongated hole extending in a first direction, and the second plate member is provided with a second elongated hole extending in a second direction, the first elongated hole and the second elongated hole being connected via a threaded fastener of the guide rail bracket assembly.

Optionally, according to an embodiment of the present disclosure, the guide rail bracket assembly further comprises a shim, wherein the shim is disposed on an end face of the first plate member, and is capable of being arranged between the end face of the first plate member and the guide rail.

Optionally, according to an embodiment of the present disclosure, the first plate member and the second plate member are both configured as an L-shaped structure, wherein a first transverse portion of the first plate member and a second transverse portion of the second plate member are connected via the threaded fastener, a first vertical portion of the first plate member and a second vertical portion of the second plate member extend parallel to a longitudinal extension direction of the guide rail, the first vertical portion is provided with a through hole extending obliquely relative to length and width directions of the first vertical portion, and the bolt secures the main body and the shim to the first vertical portion via the through hole.

Optionally, according to an embodiment of the present disclosure, the guide rail bracket assembly further comprises a backing plate provided with a first backing plate hole and a second backing plate hole, wherein the second plate member is provided with a first mating hole opposite to the first backing plate hole and a second mating hole opposite to the second backing plate hole, the first backing plate hole and the second mating hole extending in the first direction, and the second backing plate hole and the first mating hole extending in the longitudinal extension direction of the guide rail.

According to yet another aspect, an elevator system is provided, the elevator system comprising any one of the guide rail bracket assemblies described above, along with a guide rail, wherein the first portion is in abutment engagement with a side surface of the guide rail, and the second portion is in point-to-surface engagement with an end face of the guide rail.

The guide rail clip according to some embodiments of the present disclosure reduces the friction force on the guide rail, while facilitating easy processing and high cost-effectiveness, thus also lowering the requirements on the guide rail.

### BRIEF DESCRIPTION OF DRAWINGS

With reference to the accompanying drawings, the content of the present disclosure becomes more comprehensible. It is readily understood by those skilled in the art that these drawings are for illustrative purposes only, rather than intended to limit the scope of protection of the present disclosure. In addition, similar numerals in the drawings serve to denote similar components, in which:

FIG. 1 is a schematic diagram of an exemplary elevator system;

FIG. 2 shows a perspective view of a guide rail bracket assembly and a guide rail according to the present disclosure viewed from one angle;

FIG. 3 shows a perspective view of a guide rail bracket assembly and a guide rail according to the present disclosure viewed from another angle;

FIG. 4 shows a perspective view of a guide rail clip according to the present disclosure;

FIG. 5 shows a partial plan view of a guide rail bracket assembly and a guide rail according to the present disclosure viewed in the longitudinal extension direction of the guide rail; and

FIG. 6 shows an exploded view of a guide rail bracket assembly and a guide rail according to the present disclosure.

### DETAILED DESCRIPTION OF EMBODIMENTS

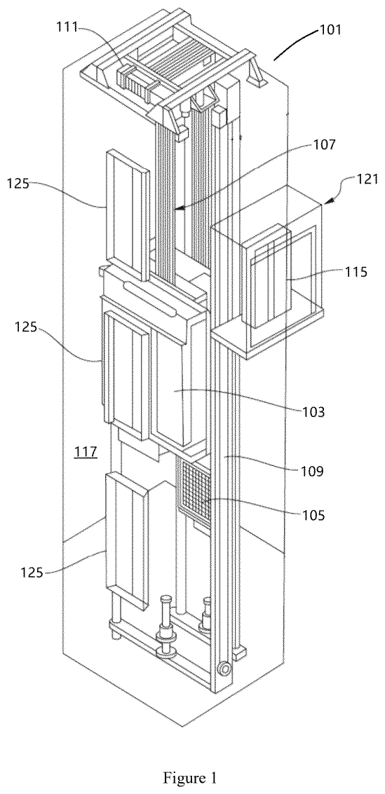

FIG. 1 is a perspective view of an elevator system 101, the elevator system comprising an elevator car 103, a counterweight 105, a cable 107, guide rails 109, a traction machine 111, and an elevator system controller 115. The elevator car 103 and the counterweight 105 are connected to each other via the cable 107. The cable 107 may comprise or be configured as, for example, a rope, a steel cable, and/or a coated steel belt. In this embodiment, the cable is configured as a cable belt integrating a plurality of cables. The counterweight 105 is configured as a load to balance the elevator car 103, and is configured to facilitate a synchronous opposite-direction movement of the elevator car 103 relative to the counterweight 105 within an elevator hoistway 117 and along the guide rails 109. The cable 107 engages with the traction machine 111, wherein the traction machine, as part of the top structure of the elevator system 101, is configured to control the movement between the elevator car 103 and the counterweight 105.

The elevator system controller 115, as shown, is positioned within an elevator system controller chamber 121 of the elevator hoistway 117 and is configured to control the operation of the elevator system 101, particularly the elevator car 103. For example, the elevator system controller 115 may provide drive signals to the traction machine 111 to control the acceleration, deceleration, leveling, stopping, etc., of the elevator car 103. When moving upward or downward along the guide rails 109 within the elevator hoistway 117, the elevator car 103, for example, under the control of the elevator system controller 115, may stop at one or more landings 125. Although shown positioned within the elevator system controller chamber 121, the elevator system controller 115 may be located and/or configured elsewhere within the elevator system 101, as those skilled in the art will appreciate. The traction machine 111 may comprise a motor or a similar drive mechanism.

While the cable system is illustrated and described, an elevator system employing other methods and mechanisms to move an elevator car within an elevator hoistway may also adopt the embodiments of the present disclosure. FIG. 1 is presented solely as a non-limiting example for illustrative and explanatory purposes.

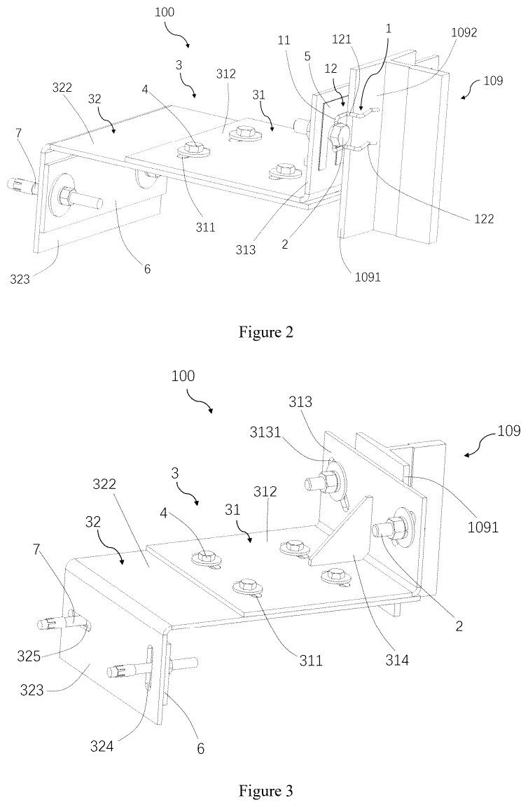

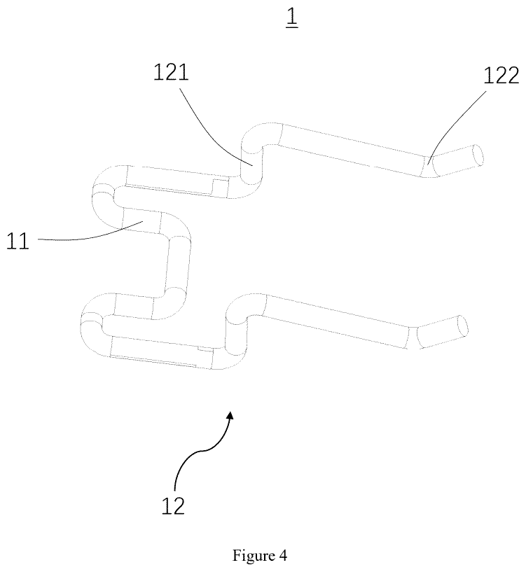

FIG. 2 shows a perspective view of a guide rail bracket assembly and a guide rail according to the present disclosure viewed from one angle; FIG. 3 shows a perspective view of a guide rail bracket assembly and a guide rail according to the present disclosure viewed from another angle; FIG. 4 shows a perspective view of a guide rail clip according to the present disclosure.

The guide rail clip 1 is intended for the guide rail bracket assembly 100 of the guide rail 109 of an elevator system 101, wherein the guide rail clip 1 comprises a main body 11 securely disposed and a clipping section 12 extending from the main body 11, a first portion 121 of the clipping section 12 is configured for abutment engagement with a side surface 1091 of the guide rail 109, and a second portion 122 of the clipping section 12 is configured for point-to-surface engagement with an end face 1092 of the guide rail 109.

As is evident according to the technical solution, the guide rail is secured by means of clipping the guide rail by the guide rail clip of the guide rail bracket assembly, thereby in turn ensuring the operation of an elevator. Moreover, the technical solution adopts two approaches to achieve clipping concurrently: on one hand, the first portion of the clipping section abuts the side surface of the guide rail, while, on the other hand, cooperating with the point-to-surface engagement of the second portion of the clipping section with the end face of the guide rail—which enables coordinated clipping of the guide rail in different directions, bringing about a stable securing effect and dispersing the clipping force to reduce stress concentration. Also, the cost of the guide rail clip, including material costs, is controlled. In this regard, the number of the guide rail clips is not limited. By way of example, the drawings illustrate two guide rail clips symmetrically arranged on both sides of the guide rail. When necessary, a plurality of guide rail clips may be provided or their positions may be changed, depending on practical requirements or cost budget.

As is particularly defined in the technical solution, the second portion of the clipping section is capable of point-to-surface engagement with the end face of the guide rail; that is, a point-like structure of the second portion of the clipping section forms a clipping engagement with the end face of the guide rail. Thus, compared with surface-to-surface engagement or line-to-surface engagement, while ensuring the basic clipping force on the guide rail, the point-to-surface engagement approach allows for effective control over the clipping force on the guide rail—for example, the compressive force perpendicular to the end face of the guide rail (reducing the compressive force on the guide rail)—such that the friction force between the guide rail clip and the guide rail is reduced in situations such as building settlement, which, in this regard, is beneficial for the service life of the guide rail and the guide rail clip while, in another aspect, can also help relax the selection requirements for the type of the guide rail (as the friction force applied by the guide rail clip in the perpendicular direction of the guide rail is effectively reduced), resulting in significant cost reduction effects. In comparison, line-to-surface or surface-to-surface engagement generates a relatively large friction force that can be superimposed with a perpendicular force on the guide rail, making the strength requirements for the guide rail more stringent. When the strength of the guide rail does not meet standards, the guide rail might be bent, and there even exists a safety risk of car derailing.

Herein, the point-to-surface engagement should be interpreted in a broad sense. The point is an ideal form and, thus, may also be broadly understood as engagement between a much smaller surface and a much larger surface. In other words, the point-to-surface engagement describes a local contact relationship, i.e., contact engagement of a point (or small area) with a surface (large area), wherein the contact area is small, and the contact part exhibits geometric features such as spherical or cylindrical shapes (e.g., bosses, contact points). Further, the abutment engagement may be construed as contact engagement, achieving positioning or constraint through the abutting contact between the clipping section and the guide rail—such contact engagement can be an interference fit, wherein internal stress or compressive force exists between the clipping section and the guide rail to enhance the securing effect.

Furthermore, the meaning of the clipping section can be understood as being line-shaped, or a shape whose dimension in the longitudinal or extension direction is significantly larger than its dimensions in other directions (e.g., a tubular structure whose length is significantly greater than its diameter), so as to better attain point-to-surface engagement. In addition, the shape of the guide rail is exemplarily a T-shape in cross-section, with both the traverse and vertical sections of the T-shaped structure having thickness. Certainly, it is sufficient that the structure be largely T-shaped. Strict requirements are not imposed, such that the structure may also be adapted to guide rails of other shapes, as long as they have a side surface and an end face.

Point-to-surface engagement may further reduce sensitivity to installation errors and lower the requirements for machining accuracy of the guide rail end face, thereby reducing the manufacturing quality requirements for the guide rail end face. Moreover, the abutment of the first portion of the clipping section with the side surface of the guide rail may adopt a line-to-surface engagement approach to establish continuous support, thereby preventing lateral displacement of the guide rail, and effectively resisting lateral vibration or impact on the guide rail caused by operation of the elevator car.

In terms of material, exemplarily, the clipping section 12 is configured as steel wire. In terms of assembly, the steel wire can better adapt to guide rail manufacturing tolerances or installation deformations, including absorbing manufacturing tolerances of the guide rail's side surface and end face, thereby lowering the manufacturing requirements for the guide rail. Furthermore, axial vibration frequency of the steel wire differs significantly from the natural frequency of the guide rail system, which can effectively avoid resonance phenomena.

Exemplarily, the steel wire may specifically be spring steel or carbon structural steel such as Q235 steel. Among them, the spring steel has advantages in terms of strength, elastic properties, and fatigue performance, while the carbon structural steel has characteristics such as cost-effectiveness, processing convenience, and feasible tensile strength. Those skilled in the art can opt for appropriate materials based on requirements such as usage scenarios, costs and manufacturing requirements.

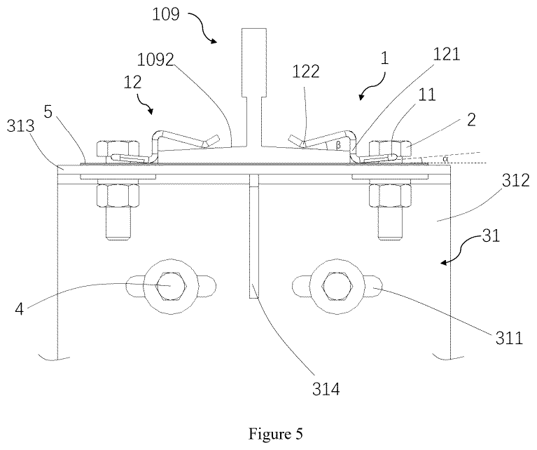

FIG. 5 shows a partial plan view of a guide rail bracket assembly and a guide rail according to the present disclosure, viewed along the longitudinal extension direction of the guide rail.

Referring to FIG. 5, viewed along the longitudinal extension direction of the guide rail 109, the first portion 121 is arranged angularly relative to the horizontal direction, which is exemplarily indicated by an angle α in FIG. 5.

As is understandable herein, that the first portion has a first section that forms an abutment engagement with the guide rail, along with a second section extending from the main body and connected to the first section. Accordingly, it may be understood that what is referred to here is that the second section is arranged angularly relative to the horizontal direction.

In this regard, such an angular design not only helps to improve the lateral anti-slip capability but also increases the structural rigidity of the guide rail clip. In another aspect, with the main body being secured by a bolt, such an angular arrangement of the first portion of the guide rail clip can create a pre-tightening force between the main body and the bolt, thus preventing the bolt from loosening due to vibration during long-term operation of the elevator. As such, a cost-effective result is achieved with this concept of simple design.

As is further visible in FIG. 5, the second portion 122 is arranged angularly relative to the end face 1092 of the guide rail 109, which is indicated by an angle β in FIG. 5. Similarly, the second portion may include a first segment in point-to-surface engagement with the end face of the guide rail, along with a second segment starting from the first portion and extending to the first segment. Then, the technical solution may be translated into the second segment being arranged angularly relative to the end face of the guide rail. It may also be understood that, on the condition that the end face of the guide rail is arc-shaped, the angle refers to an angle formed by the contact point of the second portion with the end face of the guide rail and the tangent line of the point at the arc.

The arrangement improves the longitudinal anti-slip capability and also enhances the adaptability to shape errors of the guide rail end face. In particular, through the angular design of the second portion of the guide rail clip relative to the end face of the guide rail, those skilled in the art are able to flexibly adjust the clipping force on the guide rail as required. While, on one hand, satisfying the basic clipping force on the guide rail (the minimum clipping force as required to overcome self-weight of the guide rail), on the other hand, in situations such as building settlement, the friction force between the guide rail and the guide rail clip still remains low, thereby relaxing the requirements for the type of guide rail and reducing costs. Accordingly, the angle β can be adjusted according to the specific requirements for the clipping force on the guide rail. Thus, the requirements for the clipping force on the guide rail are met in a convenient, ingenious, and highly cost-effective manner.

In some embodiments of the present disclosure, the main body 11 is capable of being at least partially arranged around an outer peripheral surface of the bolt 2 for securing the main body 11—the outer peripheral surface of the bolt may specifically refer to an outer peripheral surface of the bolt's unthreaded shank section or threaded portion. That is to say, the main body of the guide rail clip has an arranged-around section. As such, when the main body is arranged around the bolt, a thread-like engagement is formed, which can guide and limit the installation of the bolt, thereby maintaining an effective clipping area. Under the action of the pre-tightening force, a component force in the axial direction of the bolt generated between contact surfaces can also improve anti-loosening capability. Furthermore, the arranged-around structure enables loads to be transmitted dispersedly in the radial direction of the bolt, thus avoiding stress concentration and improving the fatigue life of the bolt.

The present disclosure also relates to a guide rail bracket assembly 100 for a guide rail 109 of an elevator system 101, the guide rail bracket assembly 100 comprising any one of the guide rail clips 1 described above, as well as a bolt 2 and a guide rail bracket 3, wherein the main body 11 is secured to the guide rail bracket 3 by means of the bolt 2, and the guide rail bracket 3 is capable of being securely disposed on a wall.

Thus, the guide rail bracket assembly of the present disclosure can inherit the various embodiments and corresponding technical effects pertaining to the guide rail clip, which will not be elaborated herein.

However, as is understandable, the present disclosure does not impose specific limitations on the connection mode between the guide rail bracket and the wall. Merely as an example, the guide rail bracket is connected to the wall via an expansion bolt 7, achieving reliable anchoring through mechanical interlocking action.

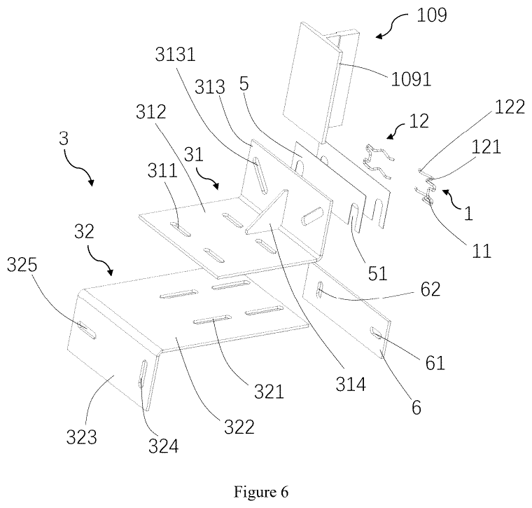

FIG. 6 shows an exploded view of a guide rail bracket assembly and a guide rail according to the present disclosure. Therein, for clarity, various threaded fasteners are removed from FIG. 6.

The guide rail bracket 3 comprises a first plate member 31 and a second plate member 32, wherein the main body 11 is secured to the first plate member 31 by means of the bolt 2, the second plate member 32 is capable of being securely disposed on a wall, the first plate member 31 is provided with a first elongated hole 311 extending in a first direction, the second plate member 32 is provided with a second elongated hole 321 extending in a second direction, and the first elongated hole 311 and the second elongated hole 321 are connected via a threaded fastener 4 of the guide rail bracket assembly 100.

It should be understood that the elongated holes refer to holes that are rectangular in the middle and arc-shaped at both ends. The elongated holes can provide space for position adjustment for a threaded connection. The threaded fasteners comprise a variety of components, such as bolts and screws, that use threads for fastening.

According to the technical solution, during the assembly process, the first plate member can be adjusted in position in the second direction, and the second plate member can be adjusted in position in the first direction, such that the entire guide rail bracket assembly can better adapt to the position of the wall or guide rail to be matched, and can compensate for manufacturing or positioning errors of a building structure or the guide rail. When building settlement causes displacement, position correction can be performed through the adjustment space provided by the elongated holes, thereby extending the service life of the entire system.

Exemplarily, the first direction and the second direction are two directions perpendicular to each other within a plane perpendicular to the longitudinal direction of the guide rail. Specifically, the first direction is the width direction of the first plate member, and the second direction is the length direction of the second plate member. Still exemplarily, there are four first elongated holes and four second elongated holes, respectively, correspondingly opposite to each other and arranged in a matrix to improve fixing stability and disperse stress.

Feasibly, the guide rail bracket assembly 100 further comprises a shim 5, wherein the shim 5 is disposed on an end face of the first plate member 31, and is capable of being arranged between the end face of the first plate member 31 and the guide rail 109.

The design of the shim may be understood as an approach of thickness adjustment, so as to compensate for or adapt to a positional difference in the thickness direction between the guide rail bracket assembly and the guide rail. The thickness direction refers to the extension direction of the second plate member towards the guide rail (the second direction), or, in other words, the length direction of the first plate member.

For this reason as well, the quantity and thickness of the shims can be adjusted according to a distance between the guide rail bracket assembly and the guide rail, for example, a distance between the second portion of the clipping section of the guide rail clip and the end face of the guide rail, so that the second portion can expectedly form a point-to-surface engagement with the end face of the guide rail. To this end, the shim can be provided with a groove 51, for example, an arc-shaped groove, to help the bolt pass through in a shape-matching manner to complete securing.

Additionally, the shim fills a gap between the guide rail and the first plate member, such that interface stress concentration is lowered, bringing about a certain vibration-damping and noise-reducing effect while serving a protective function for the surface of the guide rail bracket.

Still feasibly, the first plate member 31 and the second plate member 32 are both configured as an L-shaped structure, wherein a first transverse portion 312 of the first plate member 31 and a second transverse portion 322 of the second plate member 32 are connected via the threaded fastener 4, a first vertical portion 313 of the first plate member 31 and a second vertical portion 323 of the second plate member 32 extend parallel to the longitudinal extension direction of the guide rail 109, the first vertical portion 313 is provided with a through hole 3131 extending obliquely relative to length and width directions of the first vertical portion 313, and the bolt 2 secures the main body 11 and the shim 5 to the first vertical portion 313 via the through hole 3131.

Thus, as is understandable, the first elongated hole is provided on the first transverse portion, the second elongated hole is provided on the second transverse portion, the second vertical portion can be used for connection with the wall, and the first vertical portion serves for assembly with the guide rail. In this way, refined design is carried out for the first plate member and the second plate member, as a result of which the transverse portion and the vertical portion can fulfill functions in their respective parts, improving specificity.

The obliquely extending through hole, similar to the first and second elongated holes, also serves the function of adjusting an installation position. Specifically, through the design of the through hole, the position of the shim and the guide rail clip relative to the guide rail can be adjusted in two directions, compensating for the positional difference relative to the guide rail. Accordingly, the guide rail bracket assembly can be adapted to multiple types of guide rails. Herein, the through hole also takes the form of an elongated hole, and there are two through holes respectively arranged oppositely on both sides of the first vertical portion, so as to match the bolts and guide rail clips also arranged on both sides.

In addition, the L-shaped structure allows the first plate member and the second plate member to form perpendicularly intersecting planes, which reduces space occupation while maintaining structural strength, thereby improving compactness. As maintenance is required, damaged components (such as the first plate member) may be replaced individually without dismantling the entire bracket.

Further, a reinforcing rib 314 appearing wedge-shaped or triangular may be configured between the first vertical portion and the first transverse portion of the first plate member. As such, the triangular cross-section forms a lever arm effect, enhancing bending stiffness and improving resistance to impact or vibration.

In some embodiments of the present disclosure, the guide rail bracket assembly 100 further comprises a backing plate 6 provided with a first backing plate hole 61 and a second backing plate hole 62, wherein the second plate member 32, e.g., its second vertical portion, is provided with a first mating hole 324 opposite to the first backing plate hole 61 and a second mating hole 325 opposite to the second backing plate hole 62, the first backing plate hole 61 and the second mating hole 325 extending in the first direction, and the second backing plate hole 62 and the first mating hole 324 extending in the longitudinal extension direction of the guide rail 109.

An orthogonal adjustment system is thus formed, capable of position adjustment in the first direction and the axial extension direction of the guide rail, so as to facilitate adjustment of drilling positions for fasteners, such as expansion bolts, when, for example, encountering concrete reinforcement bars. Furthermore, the backing plate serves a reinforcing function, particularly in situations where the dimensions of the second plate member are very long.

The present disclosure also relates to an elevator system 101, wherein the elevator system 101 comprises any one of the guide rail bracket assemblies 100 described above and a guide rail 109, wherein the first portion 121 is in abutment engagement with a side surface 1091 of the guide rail 109, and the second portion 122 is in point-to-surface engagement with an end face 1092 of the guide rail 109.

Thus, the elevator system of the present disclosure can carry forward the various embodiments and corresponding technical effects of the guide rail bracket assembly, which will not be elaborated herein.

The specific embodiments described above in the present disclosure are merely for the purpose of more clearly describing the principles of the present disclosure, wherein each component is clearly shown or described to make the principles of the present disclosure more comprehensible. Without departing from the scope of the present disclosure, those skilled in the art can easily make various modifications or changes to the present disclosure. Therefore, it should be understood that these modifications or changes are all intended to be included within the scope of patent protection of the present disclosure.

What is claimed is:

1. A guide rail clip (1) for a guide rail bracket assembly (100) of a guide rail (109) of an elevator system (101), characterized in that: the guide rail clip (1) comprises a main body (11) securely disposed and a clipping section (12) extending from the main body (11), wherein a first portion (121) of the clipping section (12) is configured for abutment engagement with a side surface (1091) of the guide rail (109), and a second portion (122) of the clipping section (12) is configured for point-to-surface engagement with an end face (1092) of the guide rail (109).

2. The guide rail clip (1) according to claim 1, characterized in that: the clipping section (12) is configured as steel wire.

3. The guide rail clip (1) according to claim 1, characterized in that: viewed in a longitudinal extension direction of the guide rail (109), the first portion (121) is arranged angularly relative to a horizontal direction, and the second portion (122) is arranged angularly relative to the end face (1092) of the guide rail (109).

4. The guide rail clip (1) according to claim 1, characterized in that: the main body (11) is capable of being at least partially arranged around an outer peripheral surface of a bolt (2) for securing the main body (11).

5. A guide rail bracket assembly (100) for a guide rail (109) of an elevator system (101), characterized in that: the guide rail bracket assembly (100) comprises the guide rail clip (1) according to claim 1, a bolt (2) and a guide rail bracket (3), wherein the main body (11) is secured to the guide rail bracket (3) by means of the bolt (2), and the guide rail bracket (3) is capable of being securely disposed on a wall.

6. The guide rail bracket assembly (100) according to claim 5, characterized in that: the guide rail bracket (3) comprises a first plate member (31) and a second plate member (32), wherein the main body (11) is secured to the first plate member (31) by means of the bolt (2), the second plate member (32) is capable of being securely disposed on a wall, the first plate member (31) is provided with a first elongated hole

(311) extending in a first direction, and the second plate member (32) is provided with a second elongated hole (321) extending in a second direction, the first elongated hole (311) and the second elongated hole (321) being connected via a threaded fastener (4) of the guide rail bracket assembly (100).

7. The guide rail bracket assembly (100) according to claim 6, characterized in that: the guide rail bracket assembly (100) further comprises a shim (5), wherein the shim (5) is disposed on an end face of the first plate member (31), and is capable of being arranged between the end face of the first plate member (31) and the guide rail (109).

8. The guide rail bracket assembly (100) according to claim 7, characterized in that: the first plate member (31) and the second plate member (32) are both configured as an L-shaped structure, wherein a first transverse portion (312) of the first plate member (31) and a second transverse portion (322) of the second plate member (32) are connected via the threaded fastener (4), a first vertical portion (313) of the first plate member (31) and a second vertical portion (323) of the second plate member (32) extend parallel to a longitudinal extension direction of the guide rail (109), the first vertical portion (313) is provided with a through hole (3131) extending obliquely relative to length and width directions of the first vertical portion (313), and the bolt (2) secures the main body (11) and the shim (5) to the first vertical portion (313) via the through hole (3131).

9. The guide rail bracket assembly (100) according to claim 6, characterized in that: the guide rail bracket assembly (100) further comprises a backing plate (6) provided with a first backing plate hole (61) and a second backing plate hole (62), wherein the second plate member (32) is provided with a first mating hole (324) opposite to the first backing plate hole (61) and a second mating hole (325) opposite to the second backing plate hole (62), the first backing plate hole (61) and the second mating hole (325) extending in a first direction, and the second backing plate hole (62) and the first mating hole (324) extending in the longitudinal extension direction of the guide rail (109).

10. An elevator system (101), characterized in that: the elevator system (101) comprises the guide rail bracket assembly (100) according to claim 5 and a guide rail (109), wherein the first portion (121) is in abutment engagement with a side surface (1091) of the guide rail (109), and the second portion (122) is in point-to-surface engagement with an end face (1092) of the guide rail (109).
